(19) United States
(12) Patent Application Publication
(10) Pub. No.: US 2001/0024321 A1
(43) Pub. Date: Sep. 27, 2001

(54) MICROSCOPE WITH A PROXIMITY SENSOR

(76) Inventors: HELMUT RUEHL, GIESSEN (DE); WOLFGANG RENTZSCH, WETZLAR (DE)

Correspondence Address: RICHARD L SCHWAAB, FOLEY & LARDNER, PO BOX 25696, WASHINGTON, DC, 200078696

(21) Appl. No.: 09/284,443

(22) PCT Filed: Sep. 26, 1997
(86) PCT No.: PCT/DE97/02218

§ 371 Date: None

(30) Foreign Application Priority Data
Oct. 24, 1996 (DE) 196 43 558.7

(51) Int. Cl. G02B 21/06

(52) U.S. Cl. 359/385

(57) ABSTRACT

A microscope (1) with a viewing tube (2) for visual observation of a specimen (12) by an observer, with a control device (7) for controlling electrical and/or electric-motor-driven microscope functions, and a lighting device (14) for illuminating the specimen (12) to be observed is described. The control device (7) is connected to a proximity sensor (4) installed on the microscope (1), which responds to an approach of the observer to the viewing tube (2). On the basis of the sensor signal, those microscopic functions which are needed for observing the specimen, on the one hand, but can damage sensitive specimens by heat transfer of the lighting radiation or could impair the imaging of the specimens, on the other, are either switched off, or the strength of their effects on the specimen is reduced.

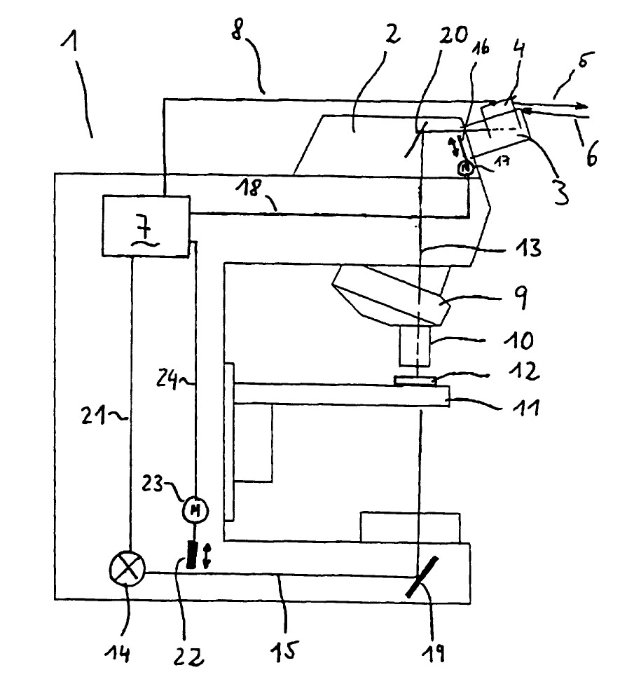

The invention relates to a microscope according to the preamble of patent claim 1.

Modern microscopes are distinguished, inter alia, by the fact that the various microscope functions are designed in such a way that they can be controlled electrically and/or by electric motor. For example, known electrically operating switching and adjusting functions are autofocusing devices, motor-driven adjustments of the specimen stage, electrically switchable shutters, filters or phase-retarding rings etc. A microscope in which these functions are realized is described, for example, in DE 42 31 379 A1.

In this microscope, the operating elements for the switching functions are grouped together in an ergonomic way on a control console and have to be manually selected by the observer. This has proved successful in practice. However, due to the large number of electrically controllable microscope functions, the area around the microscope, and consequently also the specimen to be observed, is exposed to heat. In particular when using lighting devices with very high lamp outputs, such as for example gas-discharge lamps, the specimen may be damaged by the heat to which it is exposed. Particularly sensitive specimens are, for example, living cells or else specimens in fluorescence microscopy, which may be destroyed by high luminous intensities.

The observer is in these cases obliged to deactivate or switch the switchable function manually by means of the control console. It has been found in practice that, for many applications, this procedure is always inconvenient if, for example, the microscope function is not required for a short time.

In the case of photographic cameras, it is known to arrange on or in the viewfinder a sensor which activates or deactivates the entire main circuit of the camera according to whether or not the photographer is looking into the viewfinder. In the case of cameras, this is only with the intention of saving the battery.

In the case of microscopes it is also the case that the main circuit must not be interrupted, since this would necessitate complete re-setting of the microscope when the functions were activated once again. In addition, the lifetime of lamps is reduced considerably by frequent switching on and off.

WO 96/13743 A1 discloses a microscope with a sensor and a control device, in which the microscope functions can be controlled contactlessly by the position of the observer's pupil. A device for detecting the position of the pupil is equipped with a switching element, which interrupts the measuring routine as soon as the device for detecting the position of the pupil cannot perceive a pupil.

Furthermore, DE 44 46 185 A1 discloses a laser scanning microscope with a UV laser and with an optical fiber, in which the damage caused by UV light is reduced by providing between the laser and the optical fiber a scanning shutter, which exposes the optical fiber only during scanning.

It is therefore the object of the present invention to develop a known microscope with simplest possible means in such a way that, independently of the manual operation by a person, the electrical and/or electric-motor-driven microscope functions can also be performed fully automatically, and at the same time damage to sensitive specimens or impairment of the image quality is reduced.

This object is achieved according to the invention by the features specified in the defining part of Patent Claim 1. Further advantageous developments of the invention are the subject of the subclaims.

The arrangement of a proximity sensor on or in the eyepiece and its connection to the control device make it possible for microscope functions to be controlled fully automatically. These functions are initiated whenever the user looks into the eyepiece on the tube, or if said user does not look in. This fully automatic control has proved successful in particular in fluorescence microscopy for swivelling an occulting shutter in and out of the illuminating beam. This avoids a gradual bleaching of the specimen (fading effect) being caused by unnecessary illumination.

The obscuring of the illuminating light by an occulting shutter or by regulating the lamp voltage is of course also advisable if living tissue or cells are to be observed and/or worked on using the microscope.

The proximity sensor is advantageously also used in the case of microphotographic exposures. In this case, to avoid the incidence of extraneous light through the eyepiece, an occulting shutter is swivelled into the observing beam. Of course, it is also possible to activate a beam-splitting mirror by means of the proximity sensor and the control device, so that all of the light coming from the specimen can be used for the photographic exposure.

A commercially available proximity sensor, forming a separate structural unit, may be used on the tube of the microscope. The proximity sensor may in this case be designed as a light sensor, such as for example as a reflection barrier, a forked light barrier, a passive infrared detector or an ultrasonic detector. It goes without saying that a contact-sensitive switch may also be used as the proximity sensor.

The invention is explained in more detail on the basis of an exemplary embodiment with the aid of the schematic drawing.

The FIGURE shows a microscope 1 with a tube 2 and an eyepiece 3. The microscope 1 has, furthermore, an objective turret 9 with an objective 10 and a microscope stage 11 for the specimen 12 to be observed by means of an observing beam 13. The specimen 12 is illuminated by means of a light source 14, arranged in the microscope 1, the associated illuminating beam 15 and the deflecting mirror 19. The light source 14 is electrically connected to a control device 7 by means of a line 21.

Arranged on the eyepiece 3 is a proximity sensor 4, which emits IR rays 5 and receives again reflected IR rays 6. Arranged in the microscope 1 is the control device 7, which is connected to the proximity sensor 4 by means of an electrical line 8.

A prism 20 is provided in the observing beam 13 for deflecting the light coming from the specimen 12 into the eyepiece 3. To avoid the incidence of extraneous light through the eyepiece 3, also arranged in the observing beam 13 is an eyepiece shutter 16, which is designed in such a way that it can be moved by means of a motor 17. The motor 17 is connected to the control device 7 by means of the control line 18.

A switchable occulting shutter 22, which is designed in such a way that it can be moved in the direction of the double-headed arrow by means of a motor 23, is provided in the illuminating beam 15 for obscuring the illuminating light coming from the light source 14. The motor 23 is connected to the control device 7 by means of an electrical line 24.

The proximity sensor 4 constantly emits IR rays 5. These rays 5 are reflected from an observer (not included in the representation) when said observer looks into the eyepiece 3. The reflected rays 6 are received again by the proximity sensor 4, the sensitivity of the sensor input to the reflected IR rays being of a preselectable design. The reception of IR rays 6 causes a corresponding signal to be emitted by the proximity sensor 4 via the control line 8 and to be registered in the control device 7. In this case, corresponding signals are emitted from the control device 7 via the two lines 18 and 24 to the two servo motors 17 and 23. The eyepiece shutter 16 is then swivelled out of the observing beam 13 by means of the motor 17.

In analogy with this, the occulting shutter 22 is also brought out of the illuminating beam 15 by means of the motor 23.

If no IR rays 6 reflected from the observer are received by the proximity sensor 4, a corresponding signal is triggered by means of the control device 7 and both the occulting shutter 22 and the eyepiece shutter 16 are brought back into the respective beam.

If incandescent or halogen lamps are used in the microscope 1, they can be supplied with current by means of the electrical line 21, so that a dimming of the light source 14 is possible by means of the control device 7. If no reflected IR rays 6 is [sic] received by the proximity sensor 4, the light source 14 is dimmed. If IR rays are received, the lamp 14 can be operated again at the operating voltage or operating current.

In the exemplary embodiment described, the “transmitted light” operating mode for the illuminating device is represented and described. It goes without saying that it is within the scope of the invention to use the proximity sensor in microscopes with a different type of illumination, such as for example reflected-light illumination or a combined reflected light/transmitted light illumination.

To avoid unnecessary frequent switching in the absence of the receiving [sic] IR signal, an adjustable time-delay logic is provided in the control device. This achieves the effect that the switching pulses emitted to the two motors 17 and 23 are only emitted after an adjustable time period has expired.

It is of course within the scope of the invention for other microscope functions, such as for example an autofocusing device, a photographic device or electric consumers in general, to be switched by means of the proximity sensor and the control device.

### LIST OF DESIGNATIONS

1—microscope

2—tube

3—eyepiece

4—proximity sensor

5—emitted IR rays

6—reflected IR rays

7—control device

8—electrical line 4-7

9—objective turret

10—objective

11—microscope stage

12—specimen

13—observing beam

14—light source

15—illuminating beam

16—eyepiece shutter

17—motor

18—control line 7-17

19—deflecting mirror

20—prism

21—electrical line 7-14

22—occulting shutter

23—motor

24—electrical line 7-23

1. Microscope (1) with a viewing tube (2) for the visual examination of a specimen (12) by an observer, with a control device (7) for activating electrical and/or electric-motor-driven microscope functions and with an illuminating device (14) for illuminating the specimen (12) to be observed, the control device (7) being connected to a proximity sensor (4) which is fitted on the microscope (1) and responds to the viewing tube (2) being approached by the observer and the control device (7) is designed in such a way that, on the basis of the sensor signal, those microscope functions which on the one hand are required for observing the specimen, on the other hand may damage sensitive specimens by heat transfer or by the illuminating radiation or may impair the imaging of the specimens are either switched off or the intensity of their effect on the specimen is reduced, characterized in that the control device (7) is equipped with a time-delay logic in such a way that these microscope functions are only switched once the observer has left the observing position for a predetermined time period.

2. Microscope (1) according to claim 1, characterized in that the time-delay logic of the control device (7) is of an adjustable design.

3. Microscope (1) according to claim 1 or 2, characterized in that the signal of the proximity sensor (4) controls the luminous intensity of the light source of the illuminating device (14) or controls the position of an occulting shutter (22) which can be brought into the illuminating beam.

4. Microscope (1) according to claim 1 or 2, characterized in that the control device (7) is designed in such a way that an eyepiece shutter which excludes any incidence of extraneous light through the eyepiece is activated.

5. Microscope (1) according to one of claims 1 to 4, characterized in that the proximity sensor (4) is designed either as a passive infrared detector or as an ultrasonic detector or as a contact-sensitive switch.

6. Microscope (1) according to one of claims 1 to 5, characterized in that the microscope (1) is designed as a fluorescence microscope and the proximity sensor (4) controls the specimen illumination by the exciting light.

7. Microscope (1) according to one of claims 1 to 6, characterized in that the signal of the proximity sensor (4) controls the position of a mirror in the observing beam (13), which mirror directs the specimen light alternatively either to a photographic or television camera or into the viewing tube (2).
